(19) United States
(12) Patent Application Publication
(10) Pub. No.: US 2026/0341201 A1
(43) Pub. Date: Oct. 29, 2026

(54) DISPLAY DEVICE WITH LUMINANCE ADJUSTMENT

(71) Applicant: Samsung Electronics Co., Ltd., Suwon-si (KR)

(72) Inventors: Sewoong Ahn, Suwon-si (KR); Sunkwon Kim, Suwon-si (KR); Yongil Kwon, Suwon-si (KR); Tae-Hyeon Kwon, Suwon-si (KR); Kang Joo Kim, Suwon-si (KR); Hyunwook Lim, Suwon-si (KR)

(21) Appl. No.: 19/648,221

(22) Filed: Apr. 15, 2026

(30) Foreign Application Priority Data
Apr. 24, 2025 (KR) 10-2025-0054020
Sep. 5, 2025 (KR) 10-2025-0126356

(51) Int. Cl. G09G 3/32

(52) U.S. Cl. CPC G09G 3/32; G09G 2310/08; G09G 2320/0242; G09G 2320/0285; G09G 2320/064; G09G 2360/16

(57) ABSTRACT

A display device comprises a first display pixel storing a first pixel driving data value, a luminance adjustment circuit configured to determine a plurality of adjustment parameters corresponding to the first pixel driving data value, based on one or more reference tables, and a row driver configured to control an operation of the first display pixel based on the plurality of adjustment parameters.

### CROSS-REFERENCE TO RELATED APPLICATION

Pursuant to 35 U.S.C. § 119, this application claims priority to and the benefit of Korean Patent Application No. 10-2025-0054020 filed with the Korean Patent Office on Apr. 24, 2025, and Korean Patent Application No. 10-2025-0126356 filed with the Korean Patent Office on Sep. 05, 2025, the entire contents of which are incorporated herein by reference.

### TECHNICAL FIELD

The present disclosure relates to a semiconductor display. More specifically, the present disclosure relates to a display pixel and a display device including the same.

### BACKGROUND

A display pixel that operates with a pulse width modulation (PWM) manner may include a light emission circuit that generates light in response to a PWM signal. A time length that the light emission circuit lights up may be determined based on a duty ratio of the PWM signal.

The duty ratio of the PWM signal may be determined based on a pixel driving data value stored in the display pixel. For example, the duty ratio of the PWM signal may be determined linearly with respect to the pixel driving data value. However, even if the duty ratio of the PWM signal is linearly determined according to the pixel driving data value, the luminance of the display pixel may be non-linearly determined with respect to the duty ratio of the PWM signal due to various reasons. That is, the luminance of the display pixels may become excessively higher or lower than intended due to various reasons.

### SUMMARY

The present disclosure is intended to solve the above-described technical problems. More specifically, an object of the present disclosure is to provide a display pixel whose luminance is more accurately adjusted and a display device including the same.

A display device according to some implementations may comprise: a first display pixel storing a first pixel driving data value; a luminance adjustment circuit configured to determine a plurality of adjustment parameters corresponding to the first pixel driving data value, based on one or more reference tables; and a row driver configured to control an operation of the first display pixel based on the plurality of adjustment parameters.

A display pixel according to some implementations may comprise: a pulse width modulation (PWM) generation circuit configured to generate a PWM signal corresponding to a plurality of pixel driving bits in response to a clock signal; a masking circuit configured to generate a masked PWM signal by masking the PWM signal based on a masking signal; and a light emission circuit configured to operate based on the masked PWM signal.

A display device according to some implementations may comprise: a row driver configured to output, during one frame period, a first clock signal and a second clock signal having a different waveform from the first clock signal; a first display pixel configured to perform a first light emission operation, based on a first pixel driving data value and the first clock signal; and a second display pixel configured to perform a second light emission operation, based on a second pixel driving data value and the second clock signal.

### BRIEF DESCRIPTION OF THE DRAWINGS

FIG. 1 is a block diagram showing a display device according to some implementations of the present disclosure.

FIG. 2 is a block diagram showing the configuration of the display pixels of FIG. 1 in more detail.

FIG. 3 is a timing diagram showing the configuration of a PWM signal according to some implementations.

FIG. 4 is a graph showing the relationship between a luminance of a display pixel and pixel driving data value according to the implementations of FIG. 3.

FIG. 5 is a drawing showing a luminance adjustment scheme according to some implementations of the present disclosure.

FIG. 6 is a drawing showing a luminance adjustment scheme according to some implementations of the present disclosure.

FIG. 7 is a drawing showing a luminance adjustment scheme according to some implementations of the present disclosure.

FIGS. 8 and 9 are diagrams showing the configuration of reference tables according to some implementations.

FIG. 10 is a diagram showing the configuration of a reference table according to some implementations.

FIG. 11 is a drawing showing a luminance correction method for the plurality of display pixels in more detail.

FIG. 12 is a flowchart showing an operation method of a display device according to some implementations of the present disclosure.

FIG. 13 is a graph showing the relationship between the luminance of a display pixel and pixel driving data value according to some implementations of the present disclosure.

FIGS. 14 and 15 are diagrams showing the configuration of reference tables according to some implementations.

FIG. 16 is a diagram exemplarily showing how a luminance adjustment circuit determines a light emission shortening adjustment parameter combination.

FIG. 17 is a block diagram showing a display device according to some implementations.

FIG. 18 is a diagram showing the configuration of a reference table according to some implementations.

### DETAILED DESCRIPTION

Hereinafter, implementations of the present disclosure will be described clearly and in detail to such an extent that a person having ordinary skill in the art of the present disclosure may easily practice the present disclosure.

The components described below may be implemented as various types of software, such as firmware, applications, etc., or as various types of hardware, such as electrical circuits, electronic circuits, processors, etc. However, the scope of the present disclosure is not limited thereto, and the components described below may be implemented as a combination of software and hardware.

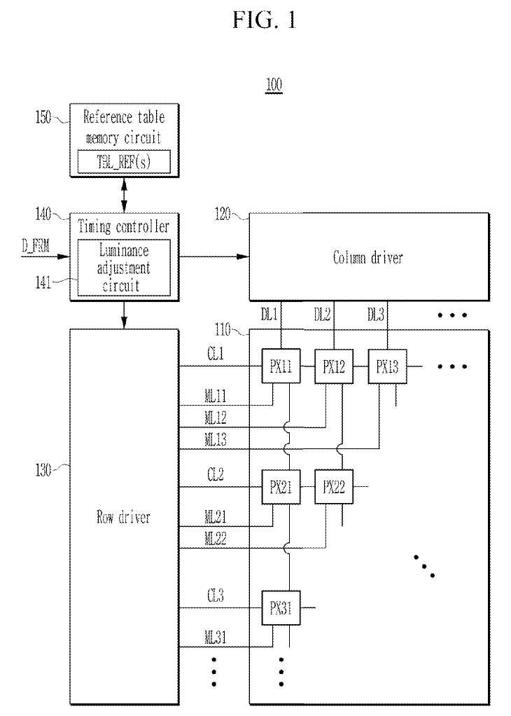

FIG. 1 is a block diagram showing a display device according to some implementations of the present disclosure. The display device 100 may include a display pixel array 110, a column driver 120, a row driver 130, a timing controller 140, and a reference table memory circuit 150.

The display pixel array 110 may include a plurality of display pixels PX. The plurality of display pixels PX may be arranged in a matrix form along a row direction and a column direction. However, the scope of the present disclosure is not limited thereto, and a plurality of display pixels PX may be arranged in a zigzag pattern.

Each of the plurality of display pixels PX may be connected to a data line DL and a clock line CL. For example, display pixels PX arranged in same display pixel row may share one clock line CL, and display pixels PX arranged in same display pixel column may share one data line DL.

In some implementations, a display pixel PX arranged in the i-th display pixel row and the j-th display pixel column of the display pixel array 110 may be referred to as “PXij”. For example, a display pixel PX connected to the i-th clock line CLi and the j-th data line DLj may be referenced as “PXij”.

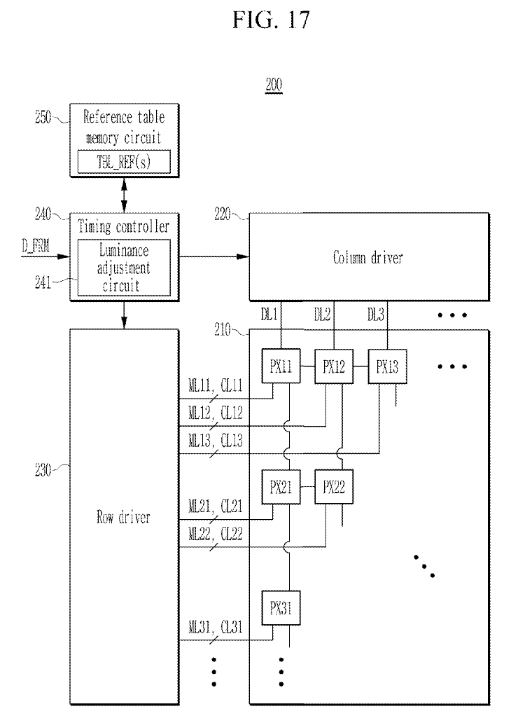

In some implementations, each of the plurality of display pixels PX may be connected to a clock line CL different from each other. Some implementations in which each of a plurality of display pixels PX is connected to a different clock line CL is described in more detail with reference to FIG. 17 below.

Each of the plurality of display pixels PX may be connected to a masking line ML different from each other. For example, a display pixel PX11 may be connected to a masking line ML11, a display pixel PX12 may be connected to a masking line ML12, and a display pixel PX13 may be connected to a masking line ML13.

The column driver 120 may control a plurality of data lines DL. For example, the column driver 120 may provide different pixel driving data value (hereinafter referred to as “PDD”) to the plurality of display pixel columns through the plurality of data lines DL.

In some implementations, the column driver 120 may provide different pixel driving data value PDD to display pixels PX arranged in one display pixel column in a time-divisional manner. For example, the column driver 120 may provide a pixel driving data value PDD to the display pixel PX11 and then provide another pixel driving data value PDD to the display pixel PX21 through the first data line DL1. However, the scope of the present disclosure is not limited thereto.

The row driver 130 may control a plurality of clock lines CL. For example, the row driver 130 may provide different clock signals (hereinafter referred to as “CLK”) to the plurality of display pixel rows through the plurality of clock lines CL.

In some implementations, the row driver 130 may control a plurality of display pixels PX in unit of display pixel row. For example, the row driver 130 may collectively (e.g., simultaneously) control an operation of display pixels PX connected to the first clock line CL1 by controlling a logic level of the clock signal CLK provided through the first clock line CL1. For a more detailed example, in response to the logic level of the clock signal CLK provided through the first clock line CL1, display pixels PX connected to the first clock line CL1 may store pixel driving data value PDD provided through the data line DL or perform a light emission operation based on the pixel driving data value PDD.

The row driver 130 may control a plurality of masking lines ML. For example, the row driver 130 may provide a plurality of masking signals (hereinafter referred to as “MSK”) to the plurality of display pixels PX through the plurality of masking lines ML. For the sake of brevity, it is assumed below that the row driver 130 controls the plurality of masking lines ML, but the scope of the present disclosure is not limited thereto. For example, the column driver 120 may be implemented to control the plurality of masking lines ML instead of the row driver 130, or a dedicated driver (not shown) other than the column driver 120 and the row driver 130 may be implemented to control the plurality of masking lines ML.

The timing controller 140 may receive frame data D_FRM from an external device (e.g., a CPU or GPU, etc.). The timing controller 140 may provide frame data D_FRM to the column driver 120. The frame data D_FRM may include a plurality of pixel driving data value PDD corresponding to different display pixels PX. The column driver 120 may divide the frame data D_FRM received from the timing controller 140 into units of pixel driving data value PDD, and may provide them to the display pixel array 110.

The timing controller 140 may control overall operations of the display device 100. For example, the timing controller 140 may control an operation timing of the column driver 120 and the row driver 130.

The timing controller 140 may include a luminance adjustment circuit 141. The luminance adjustment circuit 141 may adjust a luminance of each of the plurality of display pixels PX. For example, the luminance adjustment circuit 141 may determine a luminance adjustment target value for each display pixel PX based on one or more reference tables TBL_REF stored in the reference table memory circuit 150.

The luminance adjustment circuit 141 may adjust the luminance of each display pixel PX higher or lower than the pixel driving data value PDD based on the luminance adjustment target value. More specifically, the luminance adjustment circuit 141 may adjust the luminance of each of the plurality of display pixels PX by adjusting waveforms of the plurality of clock signals CLK and the plurality of masking signals MSK provided to the display pixel array 110. For example, the luminance adjustment circuit 141 may provide a plurality of adjustment parameters to the row driver 130. The row driver 130 may control a total light emission time length of each display pixel PX by adjusting the waveforms of the plurality of clock signals CLK and the plurality of masking signals MSK based on the plurality of adjustment parameters.

That is, below, an example will be described in which a luminance adjustment circuit 141 included in the timing controller 140 adjusts luminance of the plurality of display pixels PX by controlling the row driver 130. However, the scope of the present disclosure is not limited thereto. For example, the luminance adjustment circuit 141 may be implemented as a component included in the row driver 130, or the luminance adjustment circuit 141 may be implemented as a separate component external to the row driver 130 and the timing controller 140. That is, the scope of the present disclosure is not limited to a specific implementation method of the luminance adjustment circuit 141.

In some implementations, the reference table memory circuit 150 may be implemented as a volatile memory device such as a dynamic random access memory (DRAM), a static random access memory (SRAM), or the like. However, the scope of the present disclosure is not limited thereto, and the reference table memory circuit 150 may be implemented as a non-volatile memory device such as a flash memory.

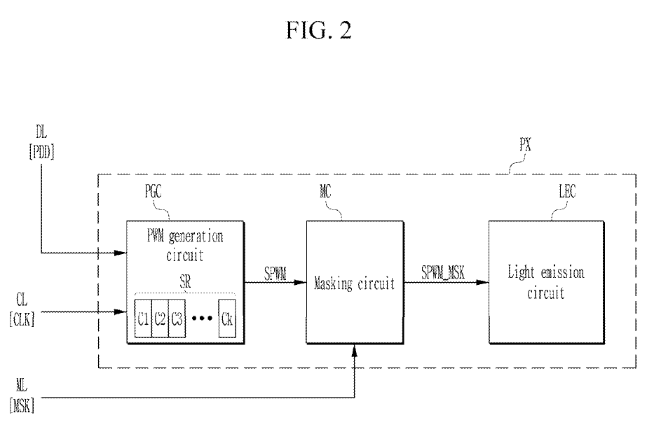

FIG. 2 is a block diagram showing the configuration of the display pixels of FIG. 1 in more detail. Referring to FIGS. 1 and 2, a display pixel PX may include a pulse width modulation (PWM) generation circuit PGC, a masking circuit MC, and a light emission circuit LEC.

The PWM generation circuit PGC may receive a clock signal CLK through a clock line CL. The PWM generation circuit PGC may store a pixel driving data value PDD provided through a data line DL in response to the clock signal CLK and may generate a PWM signal SPWM based on the pixel driving data value PDD.

The PWM signal SPWM may include the plurality of bit emission periods (hereinafter referred to as “BEM”) having logic levels corresponding to the values of the pixel driving data value PDD. The PWM generation circuit PGC may determine logic levels of a plurality of bit emission periods BEM based on bits included in the pixel driving data value PDD.

More specifically, the PWM generation circuit PGC may include a shift register SR. The shift register SR may include first to k-th bit cells C1 to Ck. The shift register SR may sequentially store bits included in the pixel driving data value PDD in response to the clock signal CLK. For example, in response to the clock signal CLK, the shift register SR may sequentially store bits included in the pixel driving data value PDD in the first to k-th bit cells C1 to Ck. The shift register SR may generate a PWM signal SPWM in response to the clock signal CLK. For example, the shift register SR may determine a logic level of the PWM signal SPWM during each bit emission period BEM, by performing a shifting operation or a rotation operation for the first to k-th bit cells C1 to Ck in response to the clock signal CLK.

In some implementations, each bit included in the pixel driving data value PDD may be referred to as a 'pixel driving bit'. However, the scope of the present disclosure is not limited to these terms.

In some implementations, each of the first to k-th bit cells C may be implemented as a flip-flop connected in series with each other, and operating in response to the clock signal CLK. However, the scope of the present disclosure is not limited thereto.

In some implementations, the PWM signal SPWM may be determined based on an output signal of the shift register SR. The logic level of the output signal of the shift register SR may be determined based on a bit stored in the last bit cell of the shift register SR (e.g., the k-th bit cell Ck).

In some implementations, the shifting operation may refer to an operation of moving bits stored in the first to (k-1)-th bit cells C1 to Ck-1 to the second to k-th bit cells C2 to Ck and storing a pixel driving bit provided from the data line DL in the first bit cell C1. The shift register SR may store the pixel driving data value PDD in the first to k-th bit cells C1 to Ck by performing the shifting operation 'k' times.

In some implementations, the rotation operation may refer to an operation of moving bits stored in the first to (k-1)-th bit cells C1 to Ck-1 to the second to k-th bit cells C2 to Ck, and storing a bit stored in the k-th bit cell Ck into the first bit cell C1. The shift register SR may perform the rotation operation to replace a bit stored in the k-th bit cell Ck with another bit included in the pixel driving data value PDD. The shift register SR may sequentially change the logic level of the PWM signal SPWM by performing the rotation operation multiple times.

The duty cycle (e.g., duty ratio) of the PWM signal SPWM may be determined according to a the pixel driving data value PDD. For example, as the pixel driving data value PDD being great, the PWM generation circuit PGC may generate the PWM signal SPWM having great proportion of time maintained at logic high; and as the pixel driving data value PDD being smaller, the PWM generation circuit PGC may generate the PWM signal SPWM having small proportion of time maintained at logic high.

The masking circuit MC may receive a masking signal MSK through a masking line ML. The masking circuit MC may generate a masked PWM signal SPWM_MSK, by masking the PWM signal SPWM based on the masking signal MSK. For example, the masking circuit MC may determine the logic level of the masked PWM signal SPWM_MSK with logic low regardless of the pixel driving data value PDD during specific time periods (e.g., time periods where the masking signal MSK is logic low) based on the masking signal MSK; and may determine the logic level of the masked PWM signal SPWM_MSK same as the PWM signal SPWM during the remaining time periods (e.g., time periods where the masking signal MSK is logic high). That is, the masking circuit MC may perform a masking operation or a bypass pass operation for the PWM signal SPWM in response to the masking signal MSK. However, the scope of the present disclosure is not limited to the specific operation method of the masking circuit MC.

In some implementations, the masking circuit MC may be implemented as an AND gate. However, the scope of the present disclosure is not limited thereto. For example, a masking circuit MC may be implemented with various types of logic gates, such as a NAND gate, depending on how the masking signal MSK is implemented.

The light emission circuit LEC may perform a light emitting operation in response to the PWM signal SPWM. For example, the light emission circuit LEC may include a light emitting diode that is turned on or off based on the logic level of the masked PWM signal SPWM_MSK.

That is, a time length where the light emission circuit LEC emits light may be determined based on the pixel driving data value PDD stored in the shift register SR. However, the luminance of a display pixel PX based on a specific pixel driving data value PDD may be higher or lower than intended by various reasons. In this case, a quality of the image represented by the display pixels PX may be degraded.

According to some implementations of the present disclosure, the luminance adjustment circuit 141 may control the waveforms of the masking signal MSK and the clock signal CLK by controlling the row driver 130. For example, the luminance adjustment circuit 141 may adjust the duty ratio of the masked PWM signal SPWM_MSK by adjusting the length of masking periods included in the masking signal MSK and toggle intervals of the clock signal CLK. However, the scope of the present disclosure is not limited thereto, and the luminance adjustment circuit 141 may also be implemented to control only one waveform of the masking signal MSK and the clock signal CLK.

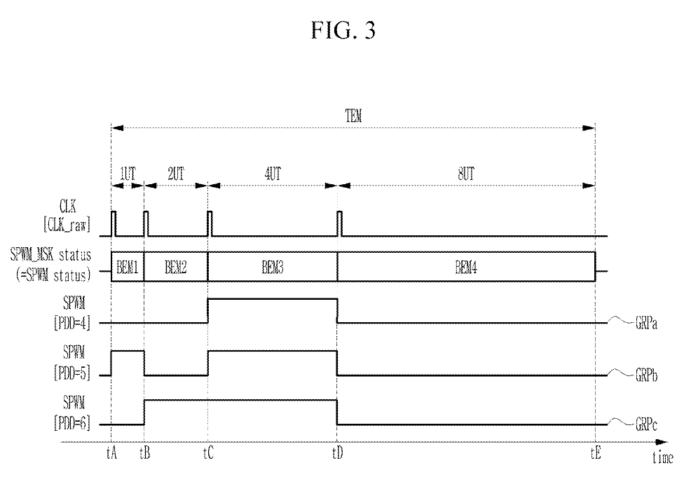

FIG. 3 is a timing diagram showing the configuration of a PWM signal according to some implementations. Hereinafter, with reference to FIGS. 1 - 3, the waveforms of the PWM signal SPWM and the masked PWM signal SPWM_MSK when the luminance adjustment circuit 141 does not adjust the masking signal MSK and the clock signal CLK will be described. In other words, in the following, it is assumed that a raw clock signal CLK_raw (e.g., a clock signal CLK generated by the row driver 130 when a toggle interval is not adjusted by the luminance adjustment circuit 141) is provided to the display pixel PX, and that the masking circuit MC maintains a waveform of the masked PWM signal SPWM_MSK identical to a waveform of the PWM signal SPWM in response to the masking signal MSK (e.g., a state in which the masking signal MSK maintains a logic high).

Also, for a more concise explanation, it is assumed below that the pixel driving data value PDD has a 4-bit code length and the capacity of the shift register SR is 4-bits (i.e., k is 4). However, the scope of the present disclosure is not limited thereto. For example, the capacity of the shift register SR and pixel driving data value PDD may be greater or less than 4 bits.

The display pixel PX may perform a light emission operation during a light emission period TEM based on pixel driving data value PDD stored in the shift register SR. For example, during a time period between a first time point tA and a fifth time point tE corresponding to a light emission period TEM, the PWM generation circuit PGC may generate the PWM signal SPWM corresponding to the pixel driving data value PDD in response to the clock signal CLK; and the light emission circuit LEC may perform the light emission operation based on the PWM signal SPWM (more precisely, a masked PWM signal SPWM_MSK same as the PWM signal SPWM).

In some implementations, a light emission period TEM may refer to a time period where the display pixel PX emits light during one frame period. For example, one display pixel PX may perform a light emission operation corresponding to one pixel driving data value PDD during one light emission period TEM.

The PWM generation circuit PGC may generate the PWM signal SPWM corresponding to pixel driving data value PDD based on the clock signal CLK. For example, the shift register SR may generate the PWM signal SPWM in response to the clock signal CLK.

The clock signal CLK may toggle (e.g., transition from logic low to logic high and then back to logic low) at each of the first to fourth time points tA to tD. In this case, in response to the toggle of the clock signal CLK, a bit stored in the last bit cell (e.g., the k-th bit cell Ck) of the shift register SR may be sequentially changed, and accordingly, the logic level of the PWM signal SPWM may be sequentially changed.

In response to the clock signal CLK toggling at the first time point tA, the shift register SR may store the least significant bit (LSB) of the pixel driving data value PDD in the k-th bit cell Ck (i.e., the last bit cell). In response to the clock signal CLK toggling at the second time point tB, the shift register SR may perform a 1-bit rotation operation to store the secondary least significant bit of the pixel driving data value PDD in the k-th bit cell Ck. In response to the clock signal CLK toggling at the third time point tC, the shift register SR performs a 1-bit rotation operation to store the secondary most significant bit of the pixel driving data value PDD in the k-th bit cell Ck. In response to the clock signal CLK toggling at the fourth time point tD, the shift register SR performs a 1-bit rotation operation to store the most significant bit (MSB) of the pixel driving data value PDD in the k-th bit cell Ck.

Accordingly, the logic level of the PWM signal SPWM during a time period between a first time point tA and a second time point tB may be determined based on the LSB of the pixel driving data value PDD; the logic level of the PWM signal SPWM during a time period between a second time point tB and a third time point tC may be determined based on the secondary least significant bit of the pixel driving data value PDD; the logic level of the PWM signal SPWM during a time period between a third time point tC and a fourth time point tD may be determined based on the secondary most significant bit of the pixel driving data value PDD; and the logic level of the PWM signal SPWM during a time period between a fourth time point tD and a fifth time point tE may be determined based on the MSB of the pixel driving data value PDD.

A light emission period TEM may include a plurality of bit emission periods BEMs. Each of the plurality of bit emission periods BEMs may correspond to a different bit included in the pixel driving data value PDD. For example, the light emission period TEM may include first to fourth bit emission periods BEM1 to BEM4.

The first to fourth bit emission periods BEM1 to BEM4 may refer to a time period where the logic level of the PWM signal SPWM is determined based on the LSB, the secondary least significant bit, the secondary most significant bit, and the MSB of the pixel driving data value PDD, respectively. For example, a first bit emission period BEM1 may correspond to a time period between a first time point tA and a second time point tB; a second bit emission period BEM2 may correspond to a time period between a second time point tB and a third time point tC; a third bit emission period BEM3 may correspond to a time period between a third time point tC and a fourth time point tD; and a fourth bit emission period BEM4 may correspond to a time period between a fourth time point tD and a fifth time point tE.

For a more concise explanation, FIG. 3 is representatively illustrated as some implementations in which the first to fourth bit emission periods BEM1 to BEM4 correspond to the LSB, the secondary least significant bit, the secondary most significant bit, and the MSB of the pixel driving data value PDD, but the scope of the present disclosure is not limited thereto. For example, an order of the first to fourth bit emission periods BEM1 to BEM4 may be determined differently (e.g., in reverse order) than that shown in FIG. 3.

A time length of each of the first to fourth bit emission periods BEM1 to BEM4 may be determined based on toggle interval of the clock signal CLK. For example, the time length of the first bit emission period BEM1 may be determined as a length of the time interval between the first time point tA and the second time point tB where the clock signal CLK toggles.

The toggle intervals of the raw clock signal CLK_raw may form a geometric sequence with a common ratio of 2. For example, the interval between the first time point tA and the second time point tB may be '1UT', the interval between the second time point tB and the third time point tC may be '2UT', the interval between the third time point tC and the fourth time point tD may be '4UT', and the interval between the fourth time point tD and the fifth time point tE may be '8UT'. Accordingly, the lengths of the first to fourth bit emission periods BEM1 to BEM4 may be '1UT', '2UT', '4UT', and '8UT', respectively. That is, the lengths of the bit emission periods BEM included in the PWM signal SPWM generated in response to the raw clock signal CLK_raw may form a geometric sequence with a common ratio of '2'.

'1UT' is only a unit used to describe the relative length of toggle intervals of a raw clock signal CLK_raw and the plurality of bit emission periods BEM, and the scope of the present disclosure is not limited to the specific time length of '1UT'.

In this way, the PWM generation circuit PGC may independently determine the logic level of the PWM signal SPWM for each bit emission period BEM based on the pixel driving data value PDD. For example, if the pixel driving data value PDD is '4' (e.g., 0100 in binary), the PWM generation circuit PGC may determine the logic level of the PWM signal SPWM during the third bit emission period BEM3 to be logic high, as shown in the first graph GRPa. When the pixel driving data value PDD is '5' (e.g., 0101 in binary), the PWM generation circuit PGC may determine the logic level of the PWM signal SPWM to logic high during the first and third bit emission periods BEM1 and BEM3, as shown in the second graph GRPb. When the pixel driving data value PDD is '6' (e.g., 0110 in binary), the PWM generation circuit PGC may determine the logic level of the PWM signal SPWM to logic high during the second and third bit emission periods BEM2 and BEM3, as shown in the third graph GRPc.

The light emission circuit LEC may emit light during a time period where the PWM signal SPWM is logic high. For example, when the pixel driving data value PDD is 4, the light emission circuit ǀ LEC may emit light during '4UT' (e.g., the third bit emission period BEM3), when the pixel driving data value PDD is 5, the light emission circuit LEC may emit light during '5UT' (e.g., the first and third bit emission periods BEM1, BEM3), and when the pixel driving data value PDD is 6, the light emission circuit LEC may emit light during '6UT' (e.g., the second and third bit emission periods BEM2, BEM3).

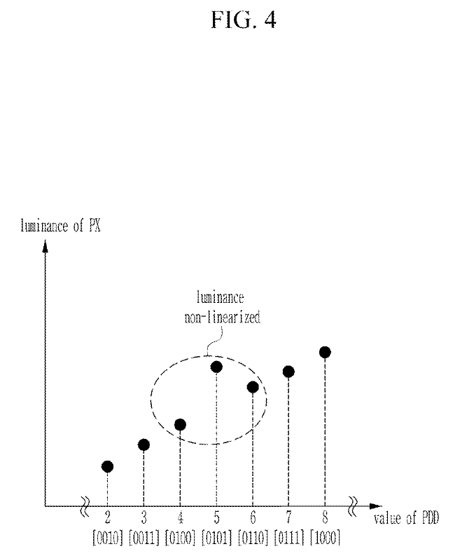

FIG. 4 is a graph showing the relationship between a luminance of a display pixel and pixel driving data value according to the implementations of FIG. 3. The horizontal axis of FIG. 4 may represent a pixel driving data value PDD, and the vertical axis of FIG. 4 may represent a luminance of the display pixel PX.

Referring to FIGS. 1 - 4, a luminance of a display pixel PX may be non-linear with respect to a the pixel driving data value PDD. For example, as described above with reference to the first to third graphs GRPa to GRPc of FIG. 3, when the pixel driving data value PDD is 4, the light emission circuit LEC may emit light for 4UT; when the pixel driving data value PDD is 5, the light emission circuit LEC may emit light for 5UT; and when the pixel driving data value PDD is 6, the light emission circuit LEC may emit light for 6UT. However, the luminance of the display pixel PX may not be linear when the pixel driving data value PDD is 4 to 6.

More specifically, the average of the luminance of a display pixel PX when the pixel driving data value PDD is 4 and the luminance of a display pixel PX when the pixel driving data value PDD is 6 may be different from the luminance of a display pixel PX when the pixel driving data value PDD is 5. For example, the luminance of a display pixel PX when the pixel driving data value PDD is 5 may be greater than the luminance of a display pixel PX when the pixel driving data value PDD is 4 and the luminance of a display pixel PX when the pixel driving data value PDD is 6. That is, if the pixel driving data value PDD is 5, the luminance of the display pixel PX may be higher than intended by the pixel driving data value PDD.

Such non-linearity in the values of the luminance and the pixel driving data value PDD of the display pixel PX may occur due to various reasons. However, for a more concise explanation, below, it is assumed that the non-linearity of luminance of the display pixel PX and the pixel driving data value PDD occurs based on difference in a number of logic level transitions for the pixel driving data value PDD. However, the scope of the present disclosure is not limited to specific reasons of nonlinearity in the luminance of display pixel PX and the pixel driving data value PDD.

The number of logic level transitions may refer to a number of times the logic level of the PWM signal SPWM generated based on pixel driving data value PDD changes during the light emission period TEM. For example, when the pixel driving data value PDD is 4, the number of logic level transitions may be '2' (e.g., the third time point tC and the fourth time point tD); when the pixel driving data value PDD is 5, the number of logic level transitions may be '4' (e.g., the first time point tA, the second time point tB, the third time point tC, and the fourth time point tD); when the pixel driving data value PDD is 6, the number of logic level transitions may be '2' (e.g., the second time point tB and the fourth time point tD). In this way, the number of logic level transitions when the pixel driving data value PDD is one of 2 to 4 and 6 to 8 may be 2, and the number of logic level transitions when the pixel driving data value PDD is 5 may be 4.

For the sake of brevity, in the following description, it is assumed that the number of logic level transitions includes the logic level transitions of the PWM signal SPWM at a start time point and an end time point of the emission period TEM, but the scope of the present disclosure is not limited thereto. For example, the number of logic level transitions may be implemented to include only logic level transitions of the PWM signal SPWM between the start time point and the end time point of the emission period TEM.

When the display pixel PX operates based on the pixel driving data value PDD corresponding to a high number of logic level transitions, the luminance of the display pixel PX may be relatively increased. When the display pixel PX operates based on pixel driving data value PDD corresponding to a low number of logic level transitions, the luminance of the display pixel PX may be relatively decreased. For example, when the pixel driving data value PDD is '5', the number of logic level transitions is '4', so the luminance of the display pixel PX may be relatively higher compared to pixel driving data value PDD (e.g., 2, 3, 4, 6, 7, 8) where the number of logic level transitions is '2'.

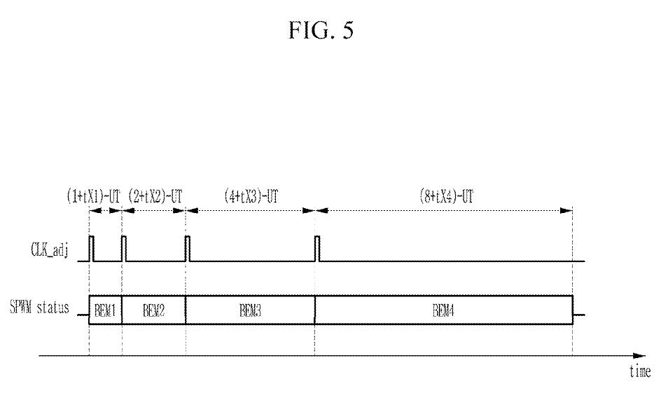

FIG. 5 is a drawing showing a luminance adjustment scheme according to some implementations of the present disclosure. Referring to FIGS. 1 - 5, the luminance adjustment circuit 141 may determine a plurality of light emission extension adjustment parameters tX. For example, the luminance adjustment circuit 141 may determine first to fourth light emission extension adjustment parameters tX1 to tX4 corresponding to the first to fourth bit emission periods BEM1 to BEM4, respectively. The first to fourth light emission extension adjustment parameters tX1 to tX4 may represent time lengths for adjusting the first to fourth bit emission periods BEM1 to BEM4, respectively.

The luminance adjustment circuit 141 may provide the first to fourth light emission extension adjustment parameters tX1 to tX4 to the row driver 130. The row driver 130 may generate an adjusted clock signal CLK_adj based on the first to fourth light emission extension adjustment parameters tX1 to tX4. For example, the row driver 130 may determine toggle intervals of the adjusted clock signal CLK_adj based on the first to fourth light emission extension adjustment parameters tX1 to tX4. For a more detailed example, the row driver 130 may determine the toggle intervals of the adjusted clock signal CLK_adj to be longer than the toggle intervals of the raw clock signal CLK_raw by the first to fourth light emission extension adjustment parameters tX1 to tX4. Accordingly, the length of the first to fourth bit emission periods BEM1 to BEM4 may be '(1+tX1)-UT', '(2+tX2)-UT', '(4+tX3)-UT', '(8+tX4)-UT'.

That is, according to the implementations of FIG. 5, the length of each bit emission period BEM may be extended based on the light emission extension adjustment parameters tX. In this case, a time length where the PWM signal SPWM maintains logic high based on one pixel driving bit may be increased, so that the luminance of the display pixel PX may be adjusted relatively higher than the pixel driving data value PDD. However, the scope of the present disclosure is not limited thereto. For example, one or more of the plurality of light emission extension adjustment parameters tX may be negative. In this case, a length of the bit emission period BEM corresponding to the negative light emission extension adjustment parameter tX may be reduced, so that the luminance of the display pixel PX may be adjusted relatively lower than the pixel driving data value PDD.

In some implementations, the luminance adjustment circuit 141 may provide the plurality of light emission extension adjustment parameters tX to the row driver 130 in a form of a light emission extension adjustment parameter combination (hereinafter, referred to as 'CMB_tX'). For example, the luminance adjustment circuit 141 may provide a light emission extension adjustment parameter combination CMB_tX including the first to fourth light emission extension adjustment parameters tX1 to tX4 to the row driver 130. However, the scope of the present disclosure is not limited thereto. For example, the row driver 130 may store a plurality of light emission extension adjustment parameter combinations CMB_tX corresponding to different identifiers, and the luminance adjustment circuit 141 may provide an identifier corresponding to one light emission extension adjustment parameter combination CMB_tX to the row driver 130.

In some implementations, the row driver 130 may generate the adjusted clock signal CLK_adj instead of the raw clock signal CLK_raw described above with reference to FIG. 3. However, the scope of the present disclosure is not limited to a specific method of generating the adjusted clock signal CLK_adj. For example, the row driver 130 may generate the adjusted clock signal CLK_adj based on the raw clock signal CLK_raw described above with reference to FIG. 3.

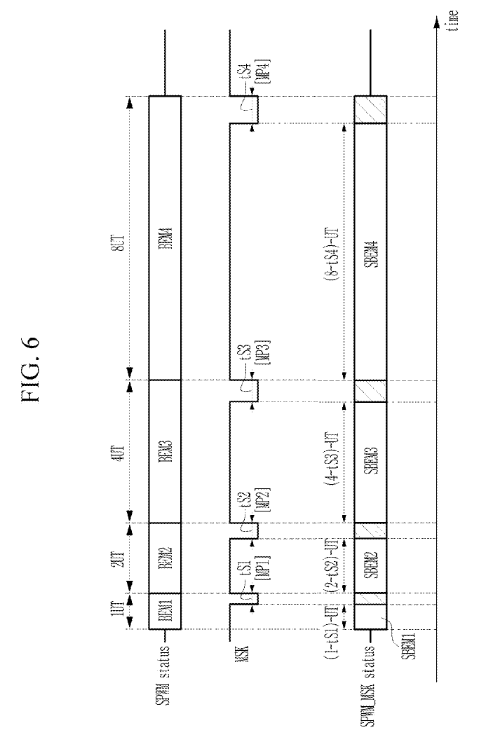

FIG. 6 is a drawing showing a luminance adjustment scheme according to some implementations of the present disclosure. Referring to FIGS. 1 - 4 and 6, the luminance adjustment circuit 141 may determine a plurality of light emission shortening adjustment parameters tS. For example, the luminance adjustment circuit 141 may determine the first to fourth light emission shortening adjustment parameters tS1 to tS4 corresponding to the first to fourth bit emission periods BEM1 to BEM4, respectively. The first to fourth light emission shortening adjustment parameters tS1 to tS4 may represent time lengths for adjusting the first to fourth bit emission periods BEM1 to BEM4, respectively.

The row driver 130 may generate a masking signal MSK. The masking signal MSK may include a plurality of masking periods MP corresponding to a plurality of bit emission periods BEM, respectively. For example, the masking signal MSK may include first to fourth masking periods MP1 to MP4. The first to fourth masking periods MP1 to MP4 may be included in the first to fourth bit emission periods BEM1 to BEM4, respectively.

The luminance adjustment circuit 141 may provide first to fourth light emission shortening adjustment parameters tS1 to tS4 to the row driver 130. The row driver 130 may generate the masking signal MSK based on the first to fourth light emission shortening adjustment parameters tS1 to tS4. The row driver 130 may determine the time lengths of the first to fourth masking periods MP1 to MP4 as time lengths corresponding to the first to fourth light emission shortening adjustment parameters tS1 to tS4, respectively.

The masking signal MSK may be logic low during the plurality of masking periods MP. Time periods that is not the plurality of masking interval MP may be referred to as a bypass period. During the bypass period, the masking signal MSK may be logic high.

The masking circuit MC may generate a masked PWM signal SPWM_MSK by masking the PWM signal SPWM based on the masking signal MSK. For example, when the masking signal MSK is logic high, the masking circuit MC may determine the logic level of the masked PWM signal SPWM_MSK to be the same as the logic level of the PWM signal SPWM. When the masking signal MSK is logic low, the masking circuit MC may determine the logic level of the masked PWM signal SPWM_MSK as logic low. That is, the masking circuit MC may determine the logic level of the masked PWM signal SPWM_MSK as logic low during the first to fourth masking periods MP1 to MP4, regardless of the pixel driving data value PDD, as illustrated by the stripes.

The masked PWM signal SPWM_MSK may include a plurality of shortened bit emission periods SBEM. The plurality of shortened bit emission periods SBEMs may correspond to a plurality of bit emission periods BEMs, respectively. For example, the masked PWM signal SPWM_MSK may include first to fourth shortened bit emission periods SBEM1 to SBEM4 corresponding to the first to fourth bit emission periods BEM1 to BEM4, respectively.

Each length of the shortened bit emission period SBEM may have length corresponding to ‘length of corresponding bit emission period BEM minus the length of corresponding masking period MP’. For example, the length of the first shortened bit emission period SBEM1 may correspond to a value obtained by subtracting the first emission shortening adjustment parameter tS1 from the length of the first bit emission period BEM1. In this way, the lengths of the first to fourth shortened bit emission periods SBEM1 to SBEM4 may be '(1-tS1)-UT', '(2-tS2)-UT', '(4-tS3)-UT', '(8-tS4)-UT'.

That is, according to the implementations of FIG. 6, a time length where the display pixel PX emits light based on one pixel driving bit may be shortened based on the light emission shortening adjustment parameter tS. In this case, a time length where the light emission circuit LEC emits light based on one pixel driving bit may be shortened, so that the luminance of the display pixel PX may be adjusted relatively lower than the pixel driving data value PDD.

In some implementations, the luminance adjustment circuit 141 may provide a plurality of light emission shortening adjustment parameters tS to the row driver 130 in a form of a light emission shortening adjustment parameter combination (hereinafter, referred to as 'CMB_tS'). For example, the luminance adjustment circuit 141 may provide a light emission shortening adjustment parameter combination CMB_tS including the first to fourth light emission shortening adjustment parameters tS1 to tS4 to the row driver 130. However, the scope of the present disclosure is not limited thereto. For example, the row driver 130 may store a plurality of light emission shortening adjustment parameter combination CMB_tS corresponding to different identifiers, and the luminance adjustment circuit 141 may provide an identifier corresponding to one light emission shortening adjustment parameter combination CMB_tS to the row driver 130.

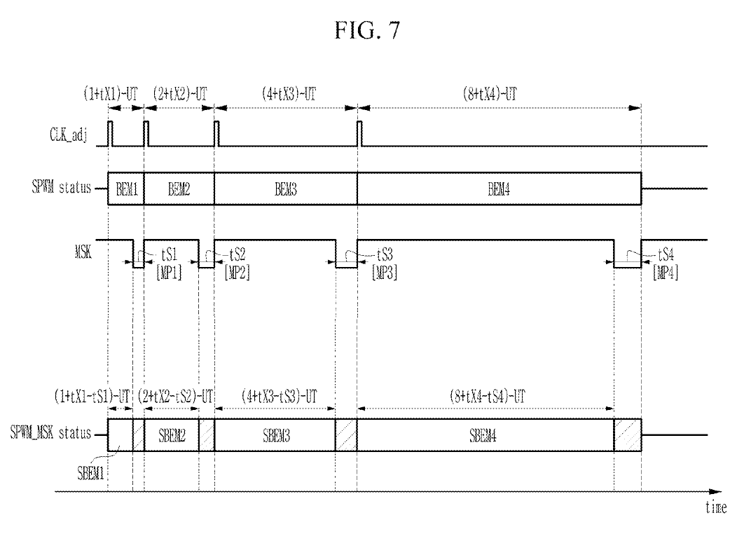

FIG. 7 is a drawing showing a luminance adjustment scheme according to some implementations of the present disclosure. Referring to FIGS. 1 - 7, the luminance adjustment circuit 141 may adjust the luminance of the display pixel PX by applying both methods described above with reference to FIGS. 5 and 6. For example, the luminance adjustment circuit 141 may determine a plurality of light emission extension adjustment parameters tX and a plurality of light emission shortening adjustment parameters tS (hereinafter, these parameters may be referred to as adjustment parameters tX, tS). More specifically, the luminance adjustment circuit 141 may determine first to fourth light emission extension adjustment parameters tX1 to tX4 and first to fourth light emission shortening adjustment parameters tS1 to tS4.

The luminance adjustment circuit 141 may provide first to fourth light emission extension adjustment parameters tX1 to tX4 and first to fourth light emission shortening adjustment parameters tS1 to tS4 to the row driver 130.

The row driver 130 may generate an adjusted clock signal CLK_adj based on the first to fourth light emission extension adjustment parameters tX1 to tX4. The PWM generation circuit PGC may generate a PWM signal SPWM based on the first to fourth light emission extension adjustment parameters tX1 to tX4. In this case, the PWM signal SPWM may include the first to fourth bit emission periods BEM1 to BEM4. The lengths of the first to fourth bit emission periods BEM1 to BEM4 may be '(1+tX1)-UT', '(2+tX2)-UT', '(4+tX3)-UT', and '(8+tX4)-UT', respectively.

The row driver 130 may generate a masking signal MSK based on the first to fourth light emission shortening adjustment parameters tS1 to tS4. The masking circuit MC may generate a masked PWM signal SPWM_MSK based on a PWM signal SPWM and a masking signal MSK. In this case, the masked PWM signal SPWM_MSK may include the first to fourth shortened bit emission periods SBEM1 to SBEM4. The lengths of the first to fourth shortened bit emission periods SBEM1 to SBEM4 may be '(1+tX1-tS1)-UT', '(2+tX2-tS2)-UT', '(4+tX3-tS3)-UT', and '(8+tX4-tS4)-UT', respectively.

That is, according to the implementations of FIG. 7, the luminance adjustment circuit 141 may increase or decrease the luminance of the display pixel PX based on the pixel driving data value PDD by adjusting the waveforms of the masking signal MSK and the clock signal CLK.

A reference table can include, for example, a pre-determined data structure stored in the reference table memory circuit 150 that associates pixel driving data values (or characteristics derived from them) with luminance adjustment reference information (e.g., logic level transition counts, luminance adjustment target values, or light emission extension/shortening adjustment parameters). The luminance adjustment reference information can be utilized by the luminance adjustment circuit 141 to determine specific adjustment parameters, which are then used to modulate signal waveforms (such as clock and masking signals) to control the total light emission time length of a pixel, thereby compensating for non-linear luminance deviations.

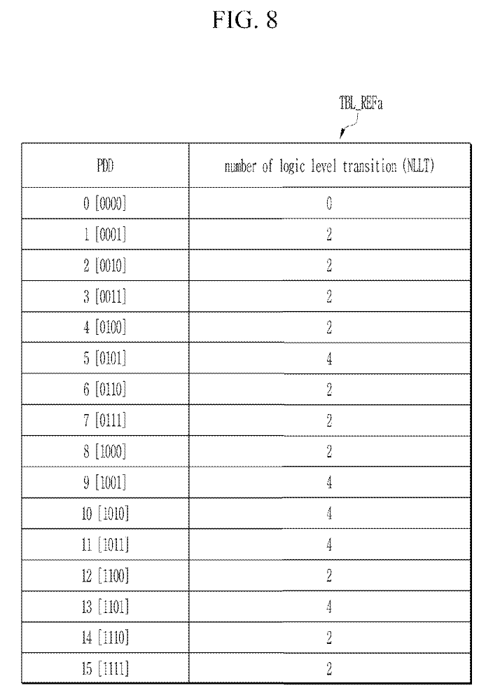

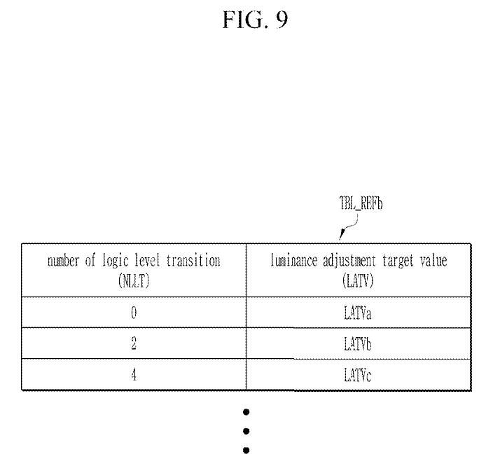

FIGS. 8 and 9 are diagrams showing the configuration of reference tables according to some implementations. Referring to FIGS. 1 - 9, the reference table memory circuit 150 may include first and second reference tables TBL_REFa, TBL_REFb.

The first reference table TBL_REFa may indicate a number of logic level transitions NLLT for each of the plurality of pixel driving data value PDD. For example, the first reference table TBL_REFa may indicate that the number of logic level transitions NLLT is 2 when the pixel driving data value PDD is 2 to 4, and may indicate that the number of logic level transitions NLLT is 4 when the pixel driving data value PDD is 5. In this way, the first reference table TBL_REFa may indicate the number of logic level transitions NLLT corresponding to each of cases where the pixel driving data value PDD is 0 to 15.

The second reference table TBL_REFb may indicate luminance adjustment target values LATV corresponding to different numbers of logic level transition NLLT. For example, the second reference table TBL_REFb may indicate that the luminance adjustment target value LATV when the number of logic level transitions NLLT is 0 is a first luminance adjustment target value LATVa; that the luminance adjustment target value LATV when the number of logic level transitions NLLT is 2 is a second luminance adjustment target value LATVb; and that the luminance adjustment target value LATV when the number of logic level transitions NLLT is 4 is a third luminance adjustment target value LATVc.

The luminance adjustment circuit 141 may identify a number of logic level transitions NLLT corresponding to the pixel driving data value PDD based on the first reference table TBL_REFa. For example, the luminance adjustment circuit 141 may identify that the number of logic level transitions NLLT corresponding to pixel driving data value PDD '5' is '4' based on the first reference table TBL_REFa.

The luminance adjustment circuit 141 may identify a luminance adjustment target value LATV corresponding to pixel driving data value PDD based on the second reference table TBL_REFb. For example, the luminance adjustment circuit 141 may identify the second luminance adjustment target value LATVb corresponding to pixel driving data value PDD '5' based on the second reference table TBL_REFb.

The luminance adjustment circuit 141 may determine a light emission extension adjustment parameter combination CMB_tX and a light emission shortening adjustment parameter combination CMB_tS (hereinafter, these combinations may be referred to as adjustment parameter combinations CMB_tX, CMB_tS) based on the identified luminance adjustment target value LATV. For example, the luminance adjustment circuit 141 may determine adjustment parameter combinations CMB_tX, CMB_tS so that the display pixel PX operating based on the pixel driving data value PDD '5' operates at a luminance that is higher by the second luminance adjustment target value LATVb compared to the case where the display pixel PX operating based on the pixel driving data value PDD '5' is driven in the manner described above with reference to FIG. 3.

In some implementations, one or more of the luminance adjustment target values LATV included in the second reference table TBL_REFb may be negative. For example, the second luminance adjustment target value LATVb may be negative. However, the scope of the present disclosure is not limited thereto.

In this way, the luminance adjustment circuit 141 may individually determine adjustment parameter combinations CMB_tX, CMB_tS for each display pixel PX based on the first reference table TBL_REFa and the second reference table TBL_REFb. In this case, the luminance of each display pixel PX may be individually adjusted depending on the number of logic level transitions NLLT corresponding to the pixel driving data value PDD. Therefore, according to some implementations of the present disclosure, the color fidelity of the display device 100 may be improved.

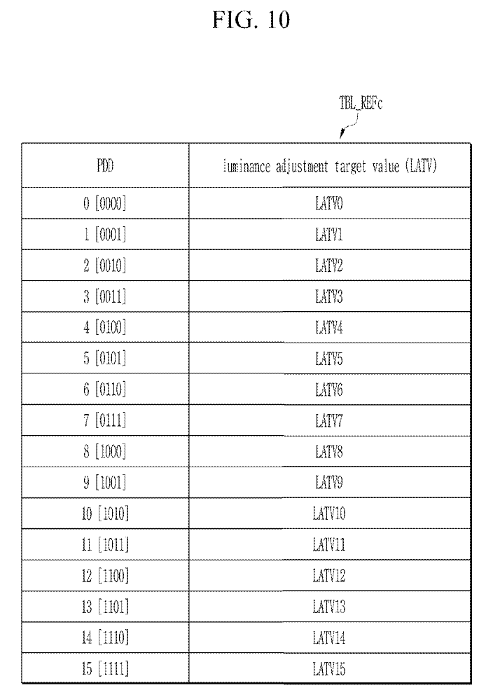

FIG. 10 is a diagram showing the configuration of a reference table according to some implementations. Referring to FIGS. 1 - 7 and 10, the reference table memory circuit 150 may include a third reference table TBL_REFc.

The third reference table TBL_REFc may indicate a luminance adjustment target value LATV for each of a plurality of pixel driving data value PDD. For example, the third reference table TBL_REFc may store the zeroth to fifteenth luminance adjustment target values LATV0 to LATV15 corresponding to cases where the pixel driving data value PDD is 0 to 15, respectively.

The luminance adjustment circuit 141 may identify a luminance adjustment target value LATV corresponding to pixel driving data value PDD based on the third reference table TBL_REFc. For example, the luminance adjustment circuit 141 may identify that the luminance adjustment target value LATV corresponding to pixel driving data value PDD '5' is the fifth luminance adjustment target value LATV5.

The luminance adjustment circuit 141 may determine adjustment parameter combinations CMB_tX, CMB_tS based on the identified luminance adjustment target value LATV. For example, the luminance adjustment circuit 141 may determine the adjustment parameter combinations CMB_tX, CMB_tS so that the display pixel PX operating based on the pixel driving data value PDD '5' operates at a luminance that is higher by the fifth luminance adjustment target value LATV5 compared to the case where the display pixel PX operating based on the pixel driving data value PDD '5' is driven in the manner described above with reference to FIG. 3.

In some implementations, one or more of the luminance adjustment target values LATV included in the third reference table TBL_REFc may be negative. For example, the fifth luminance adjustment target value LATV5 may be negative. However, the scope of the present disclosure is not limited thereto.

In this way, the luminance adjustment circuit 141 may individually determine adjustment parameter combinations CMB_tX, CMB_tS for each display pixel PX based on the third reference table TBL_REFc and the second reference table TBL_REFb. In this case, the luminance of each display pixel PX may be individually adjusted based on the pixel driving data value PDD.

Furthermore, according to the implementations of FIG. 10, unlike the implementations described with reference to FIGS. 8 - 9, the luminance adjustment target value LATV is determined for each pixel driving data value PDD, so that the color fidelity of the display device 100 may be further improved.

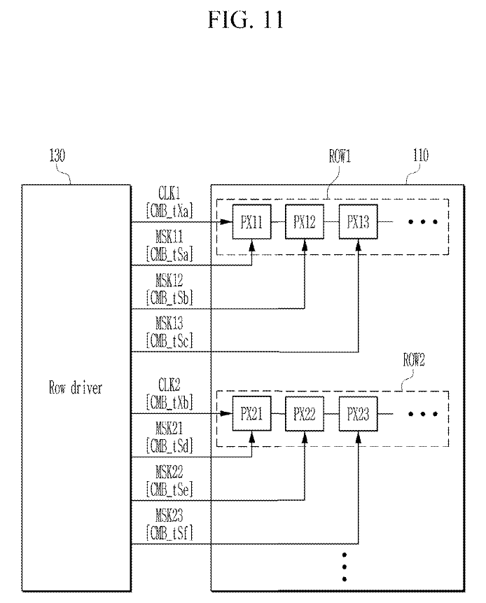

FIG. 11 is a drawing showing a luminance correction method for the plurality of display pixels in more detail. Referring to FIGS. 1 - 11, the display pixel array 110 may include a first display pixel row ROW1 and a second display pixel row ROW2. The first display pixel row ROW1 may include display pixels PX11, PX12, PX13, and the second display pixel row ROW2 may include display pixels PX21, PX22, PX23. The physical configuration of the display pixel array 110 has been described previously with reference to FIG. 1, so a detailed description is omitted.

The row driver 130 may generate a first clock signal CLK1 (e.g., as an adjusted clock signal CLK_adj) based on the first light emission extension adjustment parameter combination CMB_tXa. The row driver 130 may provide the first clock signal CLK1 to the first display pixel row ROW1.

The display pixels PX11, PX12, PX13 may receive the first clock signal CLK1 through a first clock line CL1. Accordingly, the luminance of each of the display pixels PX11, PX12, PX13 may be adjusted based on the first light emission extension adjustment parameter combination CMB_tXa.

The row driver 130 may generate a masking signal MSK11 based on the first light emission shortening adjustment parameter combination CMB_tSa, may generate a masking signal MSK12 based on the second light emission shortening adjustment parameter combination CMB_tSb, and may generate a masking signal MSK13 based on the third light emission shortening adjustment parameter combination CMB_tSc. The row driver 130 may provide masking signals MSK11 to MSK13 to the masking lines ML11 to ML13, respectively.

The display pixels PX11, PX12, PX13 may receive masking signals MSK11 to MSK13 through the masking lines ML11 to ML13, respectively. Accordingly, the luminance of the display pixels PX11, PX12, PX13 may be adjusted based on the first to third light emission shortening adjustment parameter combinations CMB_tSa to CMB_tSc, respectively.

In this way, the luminance of each of the display pixels PX11, PX12, PX13 may be collectively adjusted based on the first light emission extension adjustment parameter combination CMB_tXa, and may be independently adjusted based on the first to third light emission shortening adjustment parameter combinations CMB_tSa to CMB_tSc, respectively.

That is, the luminance adjustment circuit 141 may individually determine a luminance adjustment target value LATV for each display pixel PX based on corresponding pixel driving data value PDD (or, the number of logic level transitions NLLT), and may adjust the luminance of each display pixel PX based on the determined luminance adjustment target value LATV.

More specifically, the luminance adjustment circuit 141 may individually determine a luminance adjustment target value LATV for each display pixel PX included in the first display pixel row ROW1. The luminance adjustment circuit 141 may determine a first light emission extension adjustment parameter combination CMB_tXa by considering luminance adjustment target values LATV for display pixels PX included in a first display pixel row ROW1. Thereafter, the luminance adjustment circuit 141 may individually determine a light emission shortening adjustment parameter combination CMB_tS corresponding to each display pixel PX included in the first display pixel row ROW1 so that a luminance adjustment target value LATV corresponding to each display pixel PX included in the first display pixel row ROW1 is satisfied.

In a similar manner, the luminance adjustment circuit 141 may individually adjust the luminance of the display pixels PX included in the second display pixel row ROW2. For example, the luminance adjustment circuit 141 may determine the second light emission extension adjustment parameter combination CMB_tXb used for waveform adjustment of the second clock signal CLK2, and may determine the fourth to sixth light emission shortening adjustment parameter combinations CMB_tSd to CMB_tSf used for waveform adjustment of the masking signals MSK21 to MSK23. The method how the luminance of the display pixels PX included in the second display pixel row ROW2 is adjusted is similar to that described above with reference to the first display pixel row ROW1, so a detailed description is omitted.

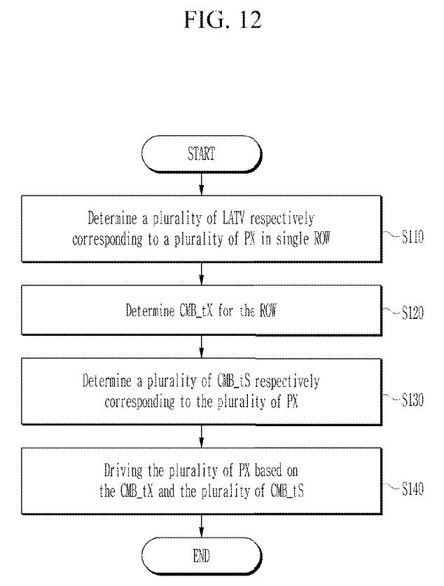

FIG. 12 is a flowchart showing an operation method of a display device according to some implementations of the present disclosure. Hereinafter, a method of controlling one display pixel row ROW is described with reference to FIGS. 1 - 12.

In operation S110, the display device 100 may determine a plurality of luminance adjustment target values LATV respectively corresponding to a plurality of display pixels PX within one display pixel row ROW. For example, the luminance adjustment circuit 141 may determine a luminance adjustment target value LATV for each of the display pixels PX11, PX12, PX13 based on one or more reference tables TBL_REF described above with reference to FIGS. 8 - 10.

At operation S120, the display device 100 may determine a light emission extension adjustment parameter combination CMB_tX for one display pixel row ROW. For example, the luminance adjustment circuit 141 may determine one light emission extension adjustment parameter combination CMB_tX based on a plurality of luminance adjustment target values LATV previously determined in operation S110.

In some implementations, the display device 100 may determine a light emission extension adjustment parameter combination CMB_tX based on a highest value among the plurality of luminance adjustment target values LATV determined in operation S110.

At operation S130, the display device 100 may determine a plurality of light emission shortening adjustment parameter combinations CMB_tS respectively corresponding to the plurality of display pixels PX. For example, the luminance adjustment circuit 141 may individually determine a light emission shortening adjustment parameter combination CMB_tS corresponding to each display pixel PX so that a luminance adjustment target value LATV corresponding to each display pixel PX is satisfied.

In operation S140, the display device 100 may drive the display pixels PX based on the light emission extension adjustment parameter combination CMB_tX and the plurality of light emission shortening adjustment parameter combinations CMB_tS determined in operations S120 and S130. For example, the luminance adjustment circuit 141 may provide the light emission extension adjustment parameter combination CMB_tX and the plurality of light emission shortening adjustment parameter combinations CMB_tS to the row driver 130. The row driver 130 may generate an adjusted clock signal CLK_adj based on the light emission extension adjustment parameter combination CMB_tX and may generate a plurality of masking signals MSK based on the plurality of light emission shortening adjustment parameter combinations CMB_tS.

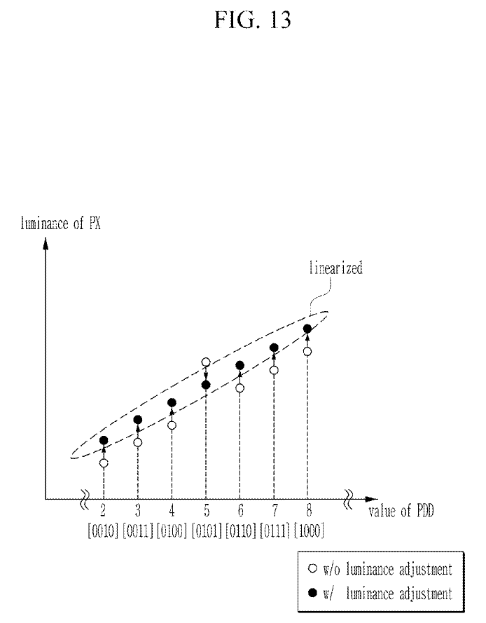

FIG. 13 is a graph showing the relationship between the luminance of a display pixel and pixel driving data value according to some implementations of the present disclosure. The horizontal axis of FIG. 13 may represent the pixel driving data value PDD, and the vertical axis of FIG. 13 may represent the luminance of a display pixel PX.

Referring to FIGS. 1 - 13, the luminance adjustment circuit 141 may adjust the luminance of the display pixel PX based on the pixel driving data value PDD. For example, by determining the light emission extension adjustment parameter combination CMB_tX and the light emission shortening adjustment parameter combination CMB_tS. the luminance adjustment circuit 141 may increase the luminance of the display pixel PX when the pixel driving data value PDD has a value corresponding to a low number of logic level transitions NLLT (e.g., 2, 3, 4, 6, 7, 8) and may decrease the luminance of the display pixel PX when the pixel driving data value PDD has a value corresponding to a high number of logic level transitions NLLT (e.g., 5). Accordingly, the luminance of the display pixel PX may be linear with respect to the pixel driving data value PDD, and the color fidelity of the display device 100 may be improved.

For a more concise explanation, FIG. 13 illustrates a representative example in which a luminance adjustment circuit 141 decreases and increases the luminance of a display pixel PX according to the pixel driving data value PDD, but the scope of the present disclosure is not limited thereto. For example, the luminance adjustment circuit 141 may linearize the luminance of the display pixel PX and the values of the pixel driving data value PDD by increasing the luminance of all the display pixels PX; or may linearize the luminance of the display pixels PX and the values of the pixel driving data value PDD by decreasing the luminance of all the display pixels PX.

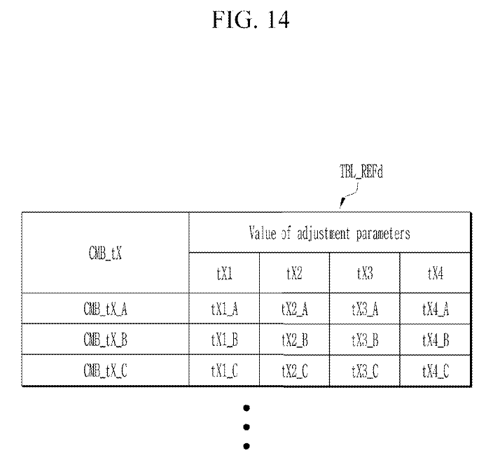

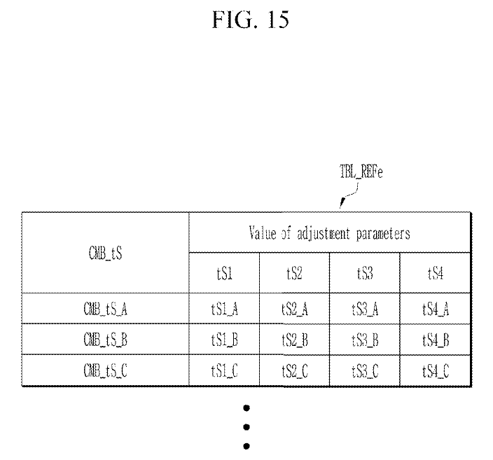

FIGS. 14 and 15 are diagrams showing the configuration of reference tables according to some implementations. Referring to FIGS. 1 - 15, the reference table memory circuit 150 may include fourth and fifth reference tables TBL_REFd, TBL_REFe. That is, the reference table memory circuit 150 may include one or more of the reference tables TBL_REF described above with reference to FIGS. 8 - 10, and the fourth and fifth reference tables TBL_REFd, TBL_REFe.

The fourth reference table TBL_REFd may store a plurality of light emission extension adjustment parameter combinations CMB_tX. For example, the fourth reference table TBL_REFd may include the first to third light emission extension adjustment parameter combinations CMB_tX_A to CMB_tX_C.

The plurality of light emission extension adjustment parameter combinations CMB_tX stored in the fourth reference table TBL_REFd may respectively correspond to different combinations of the first to fourth light emission extension adjustment parameters tX1, tX2, tX3, tX4. For example, the first light emission extension adjustment parameter combination CMB_tX_A may include light emission extension adjustment parameters tX1_A, tX2_A, tX3_A, tX4_A; and the second light emission extension adjustment parameter combination CMB_tX_B may include light emission extension adjustment parameters tX1_B, tX2_B, tX3_B, tX4_B.

The luminance adjustment circuit 141 may determine a light emission extension adjustment parameter combination CMB_tX for one display pixel row ROW based on one of the plurality of light emission extension adjustment parameter combinations CMB_tX stored in the fourth reference table TBL_REFd. That is, the luminance adjustment circuit 141 may adjust the waveform of the clock signal CLK based on one of the plurality of predetermined light emission extension adjustment parameter combinations CMB_tX.

The fifth reference table TBL_REFe may store the plurality of light emission shortening adjustment parameter combinations CMB_tS. For example, the fifth reference table TBL_REFe may include first to third light emission shortening adjustment parameter combinations CMB_tS_A to CMB_tS_C.

The plurality of light emission shortening adjustment parameter combinations CMB_tS stored in the fifth reference table TBL_REFe may respectively correspond to different combinations of the first to fourth light emission shortening adjustment parameters tS1, tS2, tS3, tS4. For example, the first light emission shortening adjustment parameter combination CMB_tS_A may include light emission shortening adjustment parameters tS1_A, tS2_A, tS3_A, tS4_A; and the second light emission shortening adjustment parameter combination CMB_tS_B may include light emission shortening adjustment parameters tS1_B, tS2_B, tS3_B, tS4_B.

The luminance adjustment circuit 141 may determine a light emission shortening adjustment parameter combination CMB_tS for each display pixel PX based on one of the plurality of light emission shortening adjustment parameter combinations CMB_tS stored in the fifth reference table TBL_REFe. That is, the luminance adjustment circuit 141 may adjust the waveform of each masking signal MSK based on one of the plurality of predetermined light emission shortening adjustment parameter combinations CMB_tS.

That is, the luminance adjustment circuit 141 may adjust the waveforms of the clock signal CLK and the masking signal MSK based on predetermined adjustment parameter combinations CMB_tX, CMB_tS. However, the scope of the present disclosure is not limited thereto, and the luminance adjustment circuit 141 may also adjust the waveforms of the clock signal CLK and the masking signal MSK based on any combination of a plurality of adjustment parameters tX, tS. That is, the scope of the present disclosure is not limited to a specific method how the luminance adjustment circuit 141 determines adjustment parameter combinations CMB_tX, CMB_tS used to adjust the waveforms of the clock signal CLK and the masking signal MSK.

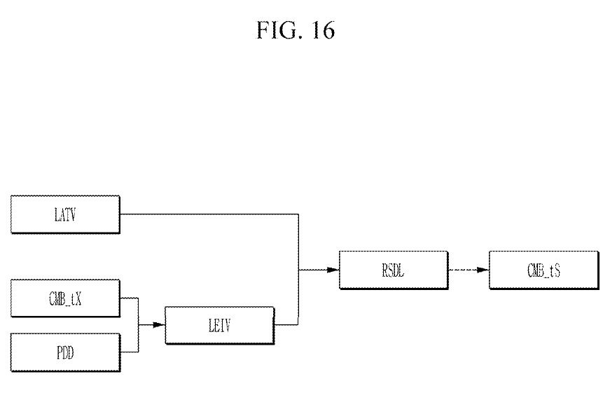

FIG. 16 is a diagram exemplarily showing how a luminance adjustment circuit determines a light emission shortening adjustment parameter combination. Hereinafter, with reference to FIGS. 1 - 16, a method for determining a light emission shortening adjustment parameter combination CMB_tS to be applied to a display pixel PX11 by a luminance adjustment circuit 141 is exemplarily described.

The luminance adjustment circuit 141 may identify a luminance adjustment target value LATV corresponding to pixel driving data value PDD stored in the display pixel PX11. For example, the luminance adjustment circuit 141 may determine a luminance adjustment target value LATV corresponding to the pixel driving data value PDD based on the first and second reference tables TBL_REFa, TBL_REFb, or may determine a luminance adjustment target value LATV corresponding to the pixel driving data value PDD based on the third reference table TBL_REFc.

The luminance adjustment circuit 141 may determine a light emission extension adjustment parameter combination CMB_tX to be applied to the display pixel PX11. For example, the luminance adjustment circuit 141 may determine the light emission extension adjustment parameter combination CMB_tX in a similar manner as described above with reference to operation S120 of FIG. 11.

More specifically, the luminance adjustment circuit 141 may determine a light emission extension adjustment parameter combination CMB_tX by considering the luminance adjustment target value LATV of each of the display pixels PX included in the first display pixel row ROW1. For example, the luminance adjustment circuit 141 may determine one of a plurality of light emission extension adjustment parameter combinations CMB_tX stored in the fourth reference table TBL_REFd as the light emission extension adjustment parameter combination CMB_tX for the first display pixel row ROW1.

The luminance adjustment circuit 141 may calculate a luminance expected increase value LEIV based on the pixel driving data value PDD stored in the display pixel PX11 and the light emission extension adjustment parameter combination CMB_tX. For example, the luminance adjustment circuit 141 may calculate the luminance expected increase value LEIV, by adding the time lengths of the bit emission periods BEM corresponding to pixel driving bits whose value is '1' included in the pixel driving data value PDD are extended by the light emission extension adjustment parameter combination CMB_tX.

The luminance adjustment circuit 141 may calculate a luminance adjustment residual value RSDL based on a luminance adjustment target value LATV and a luminance expected increase value LEIV corresponding to pixel driving data value PDD stored in the display pixel PX11. For example, the luminance adjustment circuit 141 may determine a value obtained by subtracting the luminance expected increase value LEIV from the luminance adjustment target value LATV as a luminance adjustment residual value RSDL.

The luminance adjustment circuit 141 may determine a light emission shortening adjustment parameter combination CMB_tS corresponding to pixel driving data value PDD stored in a display pixel PX11 based on the luminance adjustment residual value RSDL. For example, the luminance adjustment circuit 141 may determine one of a plurality of light emission shortening adjustment parameter combinations CMB_tS stored in the fifth reference table TBL_REFe as the light emission shortening adjustment parameter combination CMB_tS for the display pixel PX11. For a more detailed example, the luminance adjustment circuit 141 may determine the light emission shortening adjustment parameter combination CMB_tS so that the sum of the time lengths shortened by the light emission shortening adjustment parameter combination CMB_tS of the bit emission periods BEM corresponding to the pixel driving bits whose value is '1' included in the pixel driving data value PDD becomes the luminance adjustment residual value RSDL (or a similar value).

In this way, the luminance adjustment circuit 141 may adjust the waveforms of the clock signal CLK and the masking signal MSK provided to each display pixel PX according to the pixel driving data value PDD.

In some implementations, the display pixel PX may perform a light emitting operation corresponding to different pixel driving data value PDD during different frame periods. For example, pixel driving data value PDD used by a display pixel PX for light emission operation during a light emission period TEM included in a first frame period may be different from pixel driving data value PDD used by the display pixel PX for light emission operation during a light emission period TEM included in a second frame period. In this case, the waveform of the clock signal CLK and the masking signal MSK provided to the display pixel PX during the first frame period by the luminance adjustment circuit 141 may be different from the waveform of the clock signal CLK and the masking signal MSK provided to the display pixel PX during the first frame period.

FIG. 17 is a block diagram showing a display device according to some implementations. Referring to FIGS. 1 - 17, a display device 200 may include a display pixel array 210, a column driver 220, a row driver 230, a timing controller 240, and a reference table memory circuit 250. Hereinafter, the differences between the display device 200 and the display device 100 described above with reference to FIGS. 1 - 16 will be mainly described.

Each of the plurality of display pixels PX may be connected to a different clock line CL and a different masking line ML. For example, a display pixel PX11 may be connected to a masking line ML11 and a clock line CL11, and a display pixel PX12 may be connected to a masking line ML12 and a clock line CL12.

The luminance adjustment circuit 241 may independently determine a light emission extension adjustment parameter combination CMB_tX for each display pixel PX. For example, the luminance adjustment circuit 241 may apply different light emission extension adjustment parameter combination CMB_tX to display pixels PX included in one display pixel row ROW.

For a more detailed example, the luminance adjustment circuit 241 may apply different light emission extension adjustment parameter combination CMB_tX to the display pixel PX11 and the display pixel PX12. In this case, the row driver 230 may provide an adjusted clock signal CLK_adj of different waveforms to the clock line CL11 and the clock line CL12.

For a more concise explanation, FIG. 17 illustrates some implementations in which all display pixels PX included in the display pixel array 210 are connected to different clock lines CL, but the scope of the present disclosure is not limited thereto. For example, some pixels included in the display pixel array 210 may share a clock line CL. For a more detailed example, adjacent display pixels PX forming one display pixel group (e.g., a display pixel PX corresponding to red, a display pixel PX corresponding to green, and a display pixel PX corresponding to blue) may share one clock line CL.

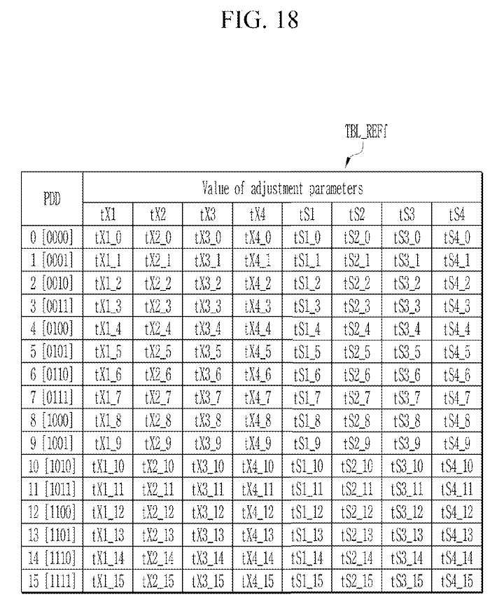

FIG. 18 is a diagram showing the configuration of a reference table according to some implementations. Referring to FIGS. 1 - 18, the reference table memory circuit 250 may include a sixth reference table TBL_REFf.

The sixth reference table TBL_REFf may indicate the plurality of adjustment parameters tX, tS for each of the plurality of pixel driving data value PDD. For example, the sixth reference table TBL_REFf may represent different combinations of a plurality of adjustment parameters tX, tS for each of the cases where the pixel driving data value PDD is 0 to 15. For example, the sixth reference table TBL_REFf may include adjustment parameters tX1_0, tX2_0, tX3_0, tX4_0, tS1_0, tS2_0, tS3_0, tS4_0 for the case where the pixel driving data value PDD is 0; and may include adjustment parameters tX1_1, tX2_1, tX3_1, tX4_1, tS1_1, tS2_1, tS3_1, tS4_1 for the case where the pixel driving data value PDD is 1.

The luminance adjustment circuit 141 may individually determine adjustment parameter combinations CMB_tX, CMB_tS for each display pixel PX based on the sixth reference table TBL_REFf. In this case, the luminance of each display pixel PX may be individually adjusted based on the pixel driving data value PDD.

For a more concise explanation, FIG. 18 is a representative example in which a luminance adjustment circuit 141 determines adjustment parameter combinations CMB_tX, CMB_tS for each display pixel PX based on the sixth reference table TBL_REFf, but the scope of the present disclosure is not limited thereto. For example, the luminance adjustment circuit 141 may be implemented to determine a luminance adjustment target value LATV for each display pixel PX in the manner described above with reference to FIGS. 8 - 10, and to determine adjustment parameter combinations CMB_tX, CMB_tS for each display pixel PX based on the luminance adjustment target value LATV.

While this specification contains many specific implementation details, these should not be construed as limitations on the scope of any invention or on the scope of what may be claimed, but rather as descriptions of features that may be specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations, one or more features from a combination can in some cases be excised from the combination, and the combination may be directed to a subcombination or variation of a subcombination.

The above-described contents are specific implementations for carrying out the present disclosure. However, the scope of the present disclosure is not limited thereto and should be determined based on the claims set forth below and their equivalents.

1. A display device, comprising:
a first display pixel configured to store a first pixel driving data value;
a luminance adjustment circuit configured to determine, based on one or more reference tables, a plurality of adjustment parameters corresponding to the first pixel driving data value; and
a row driver configured to control an operation of the first display pixel based on the plurality of adjustment parameters.

2. The display device of claim 1, wherein:
the row driver is configured to provide a first clock signal to the first display pixel;
the plurality of adjustment parameters include a plurality of light emission extension adjustment parameters; and
the row driver is configured to determine, based on the plurality of light emission extension adjustment parameters, a plurality of toggle intervals for the first clock signal.

3. The display device of claim 2, wherein:
the row driver is configured to provide a first masking signal to the first display pixel;
the plurality of adjustment parameters include a plurality of light emission shortening adjustment parameters; and
the row driver is configured to determine, based on the plurality of light emission shortening adjustment parameters, lengths of a plurality of masking periods included in the first masking signal.

4. The display device of claim 3, wherein the luminance adjustment circuit is configured to:
identify, based on the one or more reference tables, a first luminance adjustment target value corresponding to the first pixel driving data value; and
determine, based on the first luminance adjustment target value, the plurality of light emission extension adjustment parameters and the plurality of light emission shortening adjustment parameters.

5. The display device of claim 4, wherein the luminance adjustment circuit is configured to:
determine the plurality of light emission extension adjustment parameters based on the first luminance adjustment target value;
calculate a luminance expected increase value based on the plurality of light emission extension adjustment parameters and the first pixel driving data value;
calculate a luminance adjustment residual value based on the first luminance adjustment target value and the luminance expected increase value; and
determine the plurality of light emission shortening adjustment parameters based on the luminance adjustment residual value.

6. The display device of claim 4, wherein the one or more reference tables comprises:
a first reference table indicating a number of logic level transitions for each data value of a plurality of pixel driving data values, wherein the plurality of pixel driving data values include the first pixel driving data value; and
a second reference table including a first plurality of luminance adjustment target values respectively corresponding to different numbers of logic level transitions.

7. The display device of claim 4, wherein the one or more reference tables comprises:
a third reference table storing a second plurality of luminance adjustment target values respectively corresponding to a plurality of pixel driving data values, wherein the plurality of pixel driving data values include the first pixel driving data value.

8. The display device of claim 4, comprising a second display pixel configured to store a second pixel driving data value,
wherein the row driver is configured to:
provide the first clock signal to the second display pixel; and
provide a second masking signal that is different from the first masking signal to the second display pixel.

9. The display device of claim 8, wherein the luminance adjustment circuit is configured to:
identify, based on the one or more reference tables, a second luminance adjustment target value corresponding to the second pixel driving data value; and
determine, based on the first luminance adjustment target value being higher than the second luminance adjustment target value, the plurality of light emission extension parameters based on the first luminance adjustment target value.

10. The display device of claim 3, wherein the first display pixel comprises:
a pulse width modulation (PWM) generation circuit configured to generate, based on the first clock signal, a PWM signal corresponding to the first pixel driving data value;
a masking circuit configured to generate a masked PWM signal by masking the PWM signal based on the first masking signal; and
a light emission circuit configured to operate based on the masked PWM signal.

11. The display device of claim 2, comprising:
a third display pixel configured to store a third pixel driving data value; and
a column driver configured to control a first data line to provide the first pixel driving data value to the first display pixel and provide the third pixel driving data value to the third display pixel ,
wherein the row driver is configured to provide a second clock signal having a different waveform from the first clock signal to the third display pixel.

12. The display device of claim 1, wherein the row driver is configured to:
control, based on the plurality of adjustment parameters, a total light emission time length of the first display pixel based on the first pixel driving data value.

13. A display pixel, comprising:
a pulse width modulation (PWM) generation circuit configured to generate a PWM signal corresponding to a plurality of pixel driving bits based on a clock signal;
a masking circuit configured to generate a masked PWM signal by masking the PWM signal based on a masking signal; and
a light emission circuit configured to operate based on the masked PWM signal.

14. The display pixel of claim 13, wherein:
the PWM signal includes a plurality of bit emission periods respectively corresponding to the plurality of pixel driving bits,
the masking signal includes a plurality of masking periods respectively corresponding to the plurality of bit emission periods, and
a combination of lengths of the plurality of masking periods during a first frame period is different from a combination of lengths of the plurality of masking periods during a second frame period that is after the first frame period.

15. The display pixel of claim 14, wherein:
a combination of lengths of the plurality of bit emission periods during the first frame period is different from a combination of lengths of the plurality of bit emission periods during the second frame period.

16. The display pixel of claim 15, wherein the PWM generation circuit comprises a shift register configured to store the plurality of pixel driving bits and operate based on the clock signal,
wherein a waveform of the clock signal during the first frame period is different from a waveform of the clock signal during the second frame period.

17. A display device, comprising:
a row driver configured to output, during a first frame period, a first clock signal and a second clock signal having a different waveform from the first clock signal;
a first display pixel configured to perform, based on a first pixel driving data value and the first clock signal, a first light emission operation; and
a second display pixel configured to perform, based on a second pixel driving data value and the second clock signal, a second light emission operation.

18. The display device of claim 17, comprising:
a column driver configured to provide, through a first data line, the first pixel driving data value to the first display pixel and the second pixel driving data value to the second display pixel.

19. The display device of claim 17,
wherein the row driver is configured to:
generate a first masking signal based on the first pixel driving data value; and
generate a second masking signal based on the second pixel driving data value,
wherein the first display pixel is configured to:
generate a first pulse width modulation (PWM) signal based on the first pixel driving data value and the first clock signal;
generate a first masked PWM signal based on the first PWM signal and the first masking signal; and
perform the first light emission operation based on the first masked PWM signal, and
wherein the second display pixel is configured to:
generate a second PWM signal based on the second pixel driving data value and the second clock signal;
generate a second masked PWM signal based on the second PWM signal and the second masking signal; and
perform the second light emission operation based on the second masked PWM signal.

20. The display device of claim 18, comprising a luminance adjustment circuit configured to:
determine waveforms of the first clock signal and the first masking signal based on the first pixel driving data value; and
determine waveforms of the second clock signal and the second masking signal based on the second pixel driving data value.
